(19) United States
(12) Patent Application Publication
(10) Pub. No.: US 2021/0364797 A1
(43) Pub. Date: Nov. 25, 2021

(54) OPTICAL DEVICE DISPLAYING IMAGE IN SHORT-DISTANCE

(71) Applicant: LG ELECTRONICS INC., Seoul (KR)

(72) Inventors: Induck HWANG, Seoul (KR); Inho CHOI, Seoul (KR); Hoyoung CHOI, Seoul (KR); Hoon HUR, Seoul (KR)

(73) Assignee: LG ELECTRONICS INC., Seoul (KR)

(21) Appl. No.: 16/499,825

(22) PCT Filed: Aug. 27, 2019
(86) PCT No.: PCT/KR2019/010892

§ 371 Date: Sep. 30, 2019

(51) Int. Cl. G02B 27/01; G02B 5/30; G02B 25/00

(52) U.S. Cl. CPC G02B 27/0172; G02B 5/3083; G02B 25/001; G02B 2027/0138; G02B 27/0176; G02B 2027/0178; G02B 2027/014; G02B 5/3016

(57) ABSTRACT

Disclosed is an optical device including a display module according to the present disclosure. The display module according to the present disclosure may display an image in a short-distance by laminating a cholesteric liquid crystal film layer on one surface of a display panel emitting light toward an eye of a user, and sequentially disposing a reflective polarizer, a lens, a half-mirror, and a display panel on an optical axis defined by the eye of the user in a direction away from a portion adjacent to the eye. An electronic device according to the present invention may be associated with an artificial intelligence module, robot, augmented reality (AR) device, virtual reality (VR) device, and device related to 5G services.

### TECHNICAL FIELD

The present disclosure relates to an optical device displaying an image in a short-distance, and more particularly, to an optical device included in a head mounted display (HMD) used for virtual reality (VR).

### BACKGROUND ART

As a device mainly used for virtual reality (VR), a head-mounted display (HMD) refers to a digital device where a display device is worn on a head, like glasses or a helmet, and allows multimedia contents to be viewed with naked eyes.

Therefore, the HMD generally includes a display module for implementing an image.

For example, the display module may include a liquid crystal panel including a liquid crystal and an organic light emitting diode (OLED) panel including an organic light emitting device. In addition, in order to enable a user wearing the HMD to visually recognize an image implemented by the display module at a close distance to the eyes, the display module included in the HMD consists of near-eye display optics.

Unlike methods for displaying an image by transmitting light emitted from a display panel through a lens in the related art, the near-eye display optics is an optical system in which light emitted from a display panel is selectively transmitted and reflected by using a polarizer and a retarder, and thus an optical distance at which an image is displayed from the display panel is greatly reduced.

However, half of the amount of light emitted from the display panel is absorbed by a plurality of polarizers, retarders, and half-mirrors included in the near-eye display optics, which leads to a problem of reducing the overall light efficiency of the optical device.

In addition, since the plurality of components is included in the near-eye display optics, the light emitted from the display panel is reflected by each component (polarizers, retarders, and the half-mirrors), which also leads to a problem of creating a dual image.

Moreover, although the HMD continuously requires light weight and miniaturization since it is assumed to be worn on the head by the user, the fact that the plurality of components is included in the near-eye display optics causes another problem of increasing the weight of the HMD itself.

### DISCLOSURE

### Technical Problem

The present disclosure has been made to meet above-mentioned needs and to solve the problems.

An object of the present disclosure is to provide an optical device that includes a display module having increased light efficiency in being used for virtual reality (VR), augmented reality (AR), mixed reality (MR), and the like.

Another object of the present disclosure is to provide an optical device that is miniaturized and has a simple structure in a user using the optical device used for virtual reality (VR), augmented reality (AR), mixed reality (MR), and the like.

### Technical Solution

According to an embodiment of the present disclosure, there is provided an optical device including a display module. The display module includes: a display panel emitting light toward an eye of a user; a reflective polarizer reflecting the light emitted from the display panel; a lens disposed between the display panel and the reflective polarizer; and a half-mirror reflecting the light reflected from the reflective polarizer back. A cholesteric liquid crystal film layer is laminated on one surface of the display panel facing the eye, and the reflective polarizer, the lens, the half-mirror, and the display panel are sequentially disposed on an optical axis defined by the eye in a direction away from a portion adjacent to the eye.

A quarter-wave retarder film layer may be laminated on a surface of the reflective polarizer facing the display panel.

Surfaces of the half-mirror and the quarter-wave retarder film layer facing the display panel may be anti-reflection coated.

The lens may be a convex lens.

Both surfaces of the convex lens may be anti-reflection coated.

According to another embodiment of the present disclosure, there is provided an optical device including a display module. The display module includes a cholesteric liquid crystal disposed instead of the reflective polarizer. When the cholesteric liquid crystal film layer laminated on the display panel is a first cholesteric liquid crystal layer and the cholesteric liquid crystal is a second cholesteric liquid crystal layer, the first cholesteric layer right-circularly polarizes the light, and the second cholesteric layer left-circularly polarizes the light.

According to still another embodiment of the present disclosure, there is provided an optical device including a display module. The display module includes a half-mirror film layer disposed instead of the half-mirror. The half-mirror film layer is laminated on a surface of the lens facing the display panel.

The optical device according to the embodiment of the present disclosure may further include: a barrel accommodating the display module therein and disposed coaxially with the optical axis to align the display module with the optical axis; and a main frame having a space for accommodating the barrel. The barrel may include a first opening formed close to the eye and a second opening formed farther from the eye than the first opening, and the optical axis may pass through the centers of the first and second openings.

The barrel may further include an auxiliary frame closing the second opening and supporting the other surface of the display panel.

The optical device according to the embodiment of the present disclosure may include a display panel of an external digital device is disposed instead of the display panel. When the display panel is a first display panel and the display panel of the external digital device is a second display panel, the main frame may include a fixing unit fixing the external digital device. When the external digital device is mounted on the fixing unit, the second display panel may be disposed to cover the second opening and to allow second light generated in the second display panel to travel toward the eye.

The optical device according to the embodiment of the present disclosure may further include a head unit connected to the main frame. The head unit may include: a headrest surrounding the head of the user; and a band adjustable in length according to a head size of the user.

The optical device according to the embodiment of the present disclosure may further include: a sensing unit for sensing an external digital device; an inter-device communication module allowing data transmission and reception between the external digital device sensed by the sensing unit and the optical device; a processor classifying information to be displayed on the display module when the information on the external digital device is received through the inter-device communication module; and a memory storing data for operation of the optical device. The processor may be configured to classify the information into graphical user interfaces stored in advance in the memory to display the classified information on the display module.

The optical device according to the embodiment of the present disclosure may further include an input unit receiving an input of the user. The processor may be configured to execute a function corresponding to the input among functions stored in advance in the memory when the input of the user is received through the input unit.

The input unit may include a camera or an image input unit for inputting an image signal, a microphone or an audio input unit for inputting an audio signal, and a user input unit (for example, a touch key or a mechanical key) for receiving information from the user.

The sensing unit may include at least one of a proximity sensor, an illumination sensor, a touch sensor, an acceleration sensor, a magnetic sensor, a gravity (G)-sensor, a gyroscope sensor, a motion sensor, an RGB sensor, an infrared sensor (IR sensor), a fingerprint scan sensor, an ultrasonic sensor, an optical sensor, a microphone, a battery gauge, an environmental sensor including a barometer, a hygrometer, a thermometer, a radiation detection sensor, a heat detection sensor, and a gas detection sensor, and a chemical sensor including an electronic nose, a healthcare sensor, and a biometric sensor.

The optical device according to the embodiment of the present disclosure may further include at least one of a broadcast receiving module, a mobile communication module, a wireless internet module, a near field communication module, and a location information module as a network communication module.

### Advantageous Effects

An optical device according to the present disclosure has fewer components needed to constitute the optical device than that in the related art. As a result, it is possible to minimize the overall size, thickness, and weight of the optical device.

Furthermore, the optical device according to the present disclosure has fewer components needed to constitute the optical device than that in the related art. As a result, it is possible to minimize light reflection and light absorption occurring in each component, and thus enhance light efficiency.

Furthermore, the optical device according to the present disclosure uses a cholesteric liquid crystal instead of the polarizer to increase light transmittance. As a result, it is possible to increase the overall light efficiency of the optical device.

### DESCRIPTION OF DRAWINGS

FIG. 1 is a conceptual diagram illustrating an embodiment of a 5G network environment in which heterogeneous electronic devices are connected to a cloud network.

FIG. 2 is a block diagram illustrating a configuration of an electronic device including a display module according to an embodiment of the present disclosure.

FIG. 3 is a perspective view of an augmented reality electronic device according to an embodiment of the present disclosure.

FIG. 4 is an exploded perspective view illustrating a processor according to the embodiment of the present disclosure.

FIG. 5 is a diagram illustrating an embodiment of a prism type optical element.

FIG. 6 is a diagram illustrating an embodiment of a waveguide type optical element.

FIGS. 7 and 8 are diagrams illustrating an embodiment of a pin mirror type optical element.

FIG. 9 is a diagram illustrating an embodiment of a surface reflection type optical element.

FIG. 10 is a diagram illustrating an embodiment of a micro-LED type optical element.

FIG. 11 is a diagram illustrating an embodiment of a display used for a contact lens.

FIG. 12 is a diagram illustrating a configuration of a display module according to an embodiment of the present disclosure.

FIG. 13 a diagram illustrating that a cholesteric liquid crystal film layer is deposited on one surface of the display panel according to the embodiment of the present disclosure.

FIGS. 14 and 15 are diagrams illustrating examples of a barrel including the display module according to the embodiment of the present disclosure.

FIG. 16 is a diagram illustrating a configuration of a display module according to another embodiment of the present disclosure.

FIG. 17 is a diagram illustrating a configuration of a display module according to still another embodiment of the present disclosure.

### MODE FOR INVENTION

In what follows, embodiments disclosed in this document will be described in detail with reference to appended drawings, where the same or similar constituent elements are given the same reference number irrespective of their drawing symbols, and repeated descriptions thereof will be omitted.

In describing an embodiment disclosed in the present specification, if a constituting element is said to be “connected” or “attached” to other constituting element, it should be understood that the former may be connected or attached directly to the other constituting element, but there may be a case in which another constituting element is present between the two constituting elements.

Also, in describing an embodiment disclosed in the present document, if it is determined that a detailed description of a related art incorporated herein unnecessarily obscure the gist of the embodiment, the detailed description thereof will be omitted. Also, it should be understood that the appended drawings are intended only to help understand embodiments disclosed in the present document and do not limit the technical principles and scope of the present invention; rather, it should be understood that the appended drawings include all of the modifications, equivalents or substitutes described by the technical principles and belonging to the technical scope of the present invention.

[5G Scenario]

The three main requirement areas in the 5G system are (1) enhanced Mobile Broadband (eMBB) area, (2) massive Machine Type Communication (mMTC) area, and (3) Ultra-Reliable and Low Latency Communication (URLLC) area.

Some use case may require a plurality of areas for optimization, but other use case may focus only one Key Performance Indicator (KPI). The 5G system supports various use cases in a flexible and reliable manner.

eMBB far surpasses the basic mobile Internet access, supports various interactive works, and covers media and entertainment applications in the cloud computing or augmented reality environment. Data is one of core driving elements of the 5G system, which is so abundant that for the first time, the voice-only service may be disappeared. In the 5G, voice is expected to be handled simply by an application program using a data connection provided by the communication system. Primary causes of increased volume of traffic are increase of content size and increase of the number of applications requiring a high data transfer rate. Streaming service (audio and video), interactive video, and mobile Internet connection will be more heavily used as more and more devices are connected to the Internet. These application programs require always-on connectivity to push real-time information and notifications to the user. Cloud-based storage and applications are growing rapidly in the mobile communication platforms, which may be applied to both of business and entertainment uses. And the cloud-based storage is a special use case that drives growth of uplink data transfer rate. The 5G is also used for cloud-based remote works and requires a much shorter end-to-end latency to ensure excellent user experience when a tactile interface is used. Entertainment, for example, cloud-based game and video streaming, is another core element that strengthens the requirement for mobile broadband capability. Entertainment is essential for smartphones and tablets in any place including a high mobility environment such as a train, car, and plane. Another use case is augmented reality for entertainment and information search. Here, augmented reality requires very low latency and instantaneous data transfer.

Also, one of highly expected 5G use cases is the function that connects embedded sensors seamlessly in every possible area, namely the use case based on mMTC. Up to 2020, the number of potential IoT devices is expected to reach 20.4 billion. Industrial IoT is one of key areas where the 5G performs a primary role to maintain infrastructure for smart city, asset tracking, smart utility, agriculture and security.

URLLC includes new services which may transform industry through ultra-reliable/ultra-low latency links, such as remote control of major infrastructure and self-driving cars. The level of reliability and latency are essential for smart grid control, industry automation, robotics, and drone control and coordination.

Next, a plurality of use cases will be described in more detail.

The 5G may complement Fiber-To-The-Home (FTTH) and cable-based broadband (or DOCSIS) as a means to provide a stream estimated to occupy hundreds of megabits per second up to gigabits per second. This fast speed is required not only for virtual reality and augmented reality but also for transferring video with a resolution more than 4K (6K, 8K or more). VR and AR applications almost always include immersive sports games. Specific application programs may require a special network configuration. For example, in the case of VR game, to minimize latency, game service providers may have to integrate a core server with the edge network service of the network operator.

Automobiles are expected to be a new important driving force for the 5G system together with various use cases of mobile communication for vehicles. For example, entertainment for passengers requires high capacity and high mobile broadband at the same time. This is so because users continue to expect a high-quality connection irrespective of their location and moving speed. Another use case in the automotive field is an augmented reality dashboard. The augmented reality dashboard overlays information, which is a perception result of an object in the dark and contains distance to the object and object motion, on what is seen through the front window. In a future, a wireless module enables communication among vehicles, information exchange between a vehicle and supporting infrastructure, and information exchange among a vehicle and other connected devices (for example, devices carried by a pedestrian). A safety system guides alternative courses of driving so that a driver may drive his or her vehicle more safely and to reduce the risk of accident. The next step will be a remotely driven or self-driven vehicle. This step requires highly reliable and highly fast communication between different self-driving vehicles and between a self-driving vehicle and infrastructure. In the future, it is expected that a self-driving vehicle takes care of all of the driving activities while a human driver focuses on dealing with an abnormal driving situation that the self-driving vehicle is unable to recognize. Technical requirements of a self-driving vehicle demand ultra-low latency and ultra-fast reliability up to the level that traffic safety may not be reached by human drivers.

The smart city and smart home, which are regarded as essential to realize a smart society, will be embedded into a high-density wireless sensor network. Distributed networks comprising intelligent sensors may identify conditions for cost-efficient and energy-efficient conditions for maintaining cities and homes. A similar configuration may be applied for each home. Temperature sensors, window and heating controllers, anti-theft alarm devices, and home appliances will be all connected wirelessly. Many of these sensors typified with a low data transfer rate, low power, and low cost. However, for example, real-time HD video may require specific types of devices for the purpose of surveillance.

As consumption and distribution of energy including heat or gas is being highly distributed, automated control of a distributed sensor network is required. A smart grid collects information and interconnect sensors by using digital information and communication technologies so that the distributed sensor network operates according to the collected information. Since the information may include behaviors of energy suppliers and consumers, the smart grid may help improving distribution of fuels such as electricity in terms of efficiency, reliability, economics, production sustainability, and automation. The smart grid may be regarded as a different type of sensor network with a low latency.

The health-care sector has many application programs that may benefit from mobile communication. A communication system may support telemedicine providing a clinical care from a distance. Telemedicine may help reduce barriers to distance and improve access to medical services that are not readily available in remote rural areas. It may also be used to save lives in critical medical and emergency situations. A wireless sensor network based on mobile communication may provide remote monitoring and sensors for parameters such as the heart rate and blood pressure.

Wireless and mobile communication are becoming increasingly important for industrial applications. Cable wiring requires high installation and maintenance costs. Therefore, replacement of cables with reconfigurable wireless links is an attractive opportunity for many industrial applications. However, to exploit the opportunity, the wireless connection is required to function with a latency similar to that in the cable connection, to be reliable and of large capacity, and to be managed in a simple manner. Low latency and very low error probability are new requirements that lead to the introduction of the 5G system.

Logistics and freight tracking are important use cases of mobile communication, which require tracking of an inventory and packages from any place by using location-based information system. The use of logistics and freight tracking typically requires a low data rate but requires large-scale and reliable location information.

The present invention to be described below may be implemented by combining or modifying the respective embodiments to satisfy the aforementioned requirements of the 5G system.

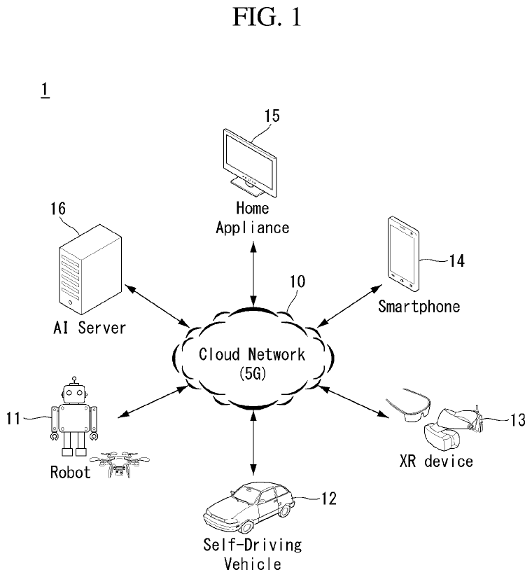

FIG. 1 is a conceptual diagram illustrating an embodiment of a 5G network environment in which heterogeneous electronic devices are connected to a cloud network.

Referring to FIG. 1, in the AI system, at least one or more of an AI server 16, robot 11, self-driving vehicle 12, XR device 13, smartphone 14, or home appliance 15 are connected to a cloud network 10. Here, the robot 11, self-driving vehicle 12, XR device 13, smartphone 14, or home appliance 15 to which the AI technology has been applied may be referred to as an AI device (11 to 15).

The cloud network 10 may comprise part of the cloud computing infrastructure or refer to a network existing in the cloud computing infrastructure. Here, the cloud network 10 may be constructed by using the 3G network, 4G or Long Term Evolution (LTE) network, or 5G network.

In other words, individual devices (11 to 16) constituting the AI system may be connected to each other through the cloud network 10. In particular, each individual device (11 to 16) may communicate with each other through the eNB but may communicate directly to each other without relying on the eNB.

The AI server 16 may include a server performing AI processing and a server performing computations on big data.

The AI server 16 may be connected to at least one or more of the robot 11, self-driving vehicle 12, XR device 13, smartphone 14, or home appliance 15, which are AI devices constituting the AI system, through the cloud network 10 and may help at least part of AI processing conducted in the connected AI devices (11 to 15).

At this time, the AI server 16 may teach the artificial neural network according to a machine learning algorithm on behalf of the AI device (11 to 15), directly store the learning model, or transmit the learning model to the AI device (11 to 15).

At this time, the AI server 16 may receive input data from the AI device (11 to 15), infer a result value from the received input data by using the learning model, generate a response or control command based on the inferred result value, and transmit the generated response or control command to the AI device (11 to 15).

Similarly, the AI device (11 to 15) may infer a result value from the input data by employing the learning model directly and generate a response or control command based on the inferred result value.

<AI+XR>

By employing the AI technology, the XR device 13 may be implemented as a Head-Mounted Display (HMD), Head-Up Display (HUD) installed at the vehicle, TV, mobile phone, smartphone, computer, wearable device, home appliance, digital signage, vehicle, robot with a fixed platform, or mobile robot.

The XR device 13 may obtain information about the surroundings or physical objects by generating position and attribute data about 3D points by analyzing 3D point cloud or image data acquired from various sensors or external devices and output objects in the form of XR objects by rendering the objects for display.

The XR device 13 may perform the operations above by using a learning model built on at least one or more artificial neural networks. For example, the XR device 13 may recognize physical objects from 3D point cloud or image data by using the learning model and provide information corresponding to the recognized physical objects. Here, the learning model may be the one trained by the XR device 13 itself or trained by an external device such as the AI server 16.

At this time, the XR device 13 may perform the operation by generating a result by employing the learning model directly but also perform the operation by transmitting sensor information to an external device such as the AI server 16 and receiving a result generated accordingly.

[Extended Reality Technology]

eXtended Reality (XR) refers to all of Virtual Reality (VR), Augmented Reality (AR), and Mixed Reality (MR). The VR technology provides objects or backgrounds of the real world only in the form of CG images, AR technology provides virtual CG images overlaid on the physical object images, and MR technology employs computer graphics technology to mix and merge virtual objects with the real world.

MR technology is similar to AR technology in a sense that physical objects are displayed together with virtual objects. However, while virtual objects supplement physical objects in the AR, virtual and physical objects co-exist as equivalents in the MR.

The XR technology may be applied to Head-Mounted Display (HMD), Head-Up Display (HUD), mobile phone, tablet PC, laptop computer, desktop computer, TV, digital signage, and so on, where a device employing the XR technology may be called an XR device.

The electronic device 20 including the display module according to the present specification will be described as an example of being implemented as the XR device 13 among the above-described devices. In particular, for convenience of description of the present specification, the electronic device 20 including the display module is described as an example of being implemented as an AR device among the XR apparatuses 13 described above.

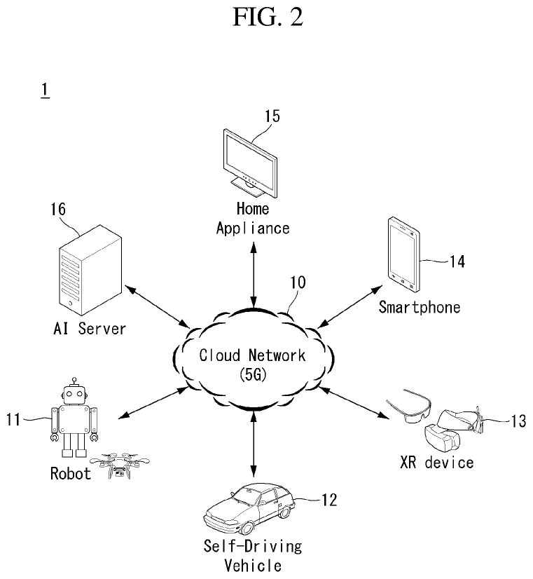

Hereinafter, an electronic device device 20 including a display module for providing an extended reality according to an exemplary embodiment of the present specification will be described with reference to FIG. 2.

FIG. 2 is a block diagram illustrating the structure of an XR electronic device 20 according to one embodiment of the present invention.

Referring to FIG. 2, the XR electronic device 20 may include a wireless communication unit 21, input unit 22, sensing unit 23, output unit 24, interface unit 25, memory 26, controller 27, and power supply unit 28. The constituting elements shown in FIG. 2 are not essential for implementing the electronic device 20, and therefore, the electronic device 20 described in this document may have more or fewer constituting elements than those listed above.

More specifically, among the constituting elements above, the wireless communication unit 21 may include one or more modules which enable wireless communication between the electronic device 20 and a wireless communication system, between the electronic device 20 and other electronic device, or between the electronic device 20 and an external server. Also, the wireless communication unit 21 may include one or more modules that connect the electronic device 20 to one or more networks.

The wireless communication unit 21 may include at least one of a broadcast receiving module, mobile communication module, wireless Internet module, short-range communication module, and location information module.

The input unit 22 may include a camera or image input unit for receiving an image signal, microphone or audio input unit for receiving an audio signal, and user input unit (for example, touch key) for receiving information from the user, and push key (for example, mechanical key). Voice data or image data collected by the input unit 22 may be analyzed and processed as a control command of the user.

The sensing unit 23 may include one or more sensors for sensing at least one of the surroundings of the electronic device 20 and user information.

For example, the sensing unit 23 may include at least one of a proximity sensor, illumination sensor, touch sensor, acceleration sensor, magnetic sensor, G-sensor, gyroscope sensor, motion sensor, RGB sensor, infrared (IR) sensor, finger scan sensor, ultrasonic sensor, optical sensor (for example, image capture means), microphone, battery gauge, environment sensor (for example, barometer, hygrometer, radiation detection sensor, heat detection sensor, and gas detection sensor), and chemical sensor (for example, electronic nose, health-care sensor, and biometric sensor). Meanwhile, the electronic device 20 disclosed in the present specification may utilize information collected from at least two or more sensors listed above.

The output unit 24 is intended to generate an output related to a visual, aural, or tactile stimulus and may include at least one of a display unit, sound output unit, haptic module, and optical output unit. The display unit may implement a touchscreen by forming a layered structure or being integrated with touch sensors. The touchscreen may not only function as a user input means for providing an input interface between the AR electronic device 20 and the user but also provide an output interface between the AR electronic device 20 and the user.

The interface unit 25 serves as a path to various types of external devices connected to the electronic device 20. Through the interface unit 25, the electronic device 20 may receive VR or AR content from an external device and perform interaction by exchanging various input signals, sensing signals, and data.

For example, the interface unit 25 may include at least one of a wired/wireless headset port, external charging port, wired/wireless data port, memory card port, port for connecting to a device equipped with an identification module, audio Input/Output (I/O) port, video I/O port, and earphone port.

Also, the memory 26 stores data supporting various functions of the electronic device 20. The memory 26 may store a plurality of application programs (or applications) executed in the electronic device 20; and data and commands for operation of the electronic device 20. Also, at least part of the application programs may be pre-installed at the electronic device 20 from the time of factory shipment for basic functions (for example, incoming and outgoing call function and message reception and transmission function) of the electronic device 20.

The controller 27 usually controls the overall operation of the electronic device 20 in addition to the operation related to the application program. The controller 27 may process signals, data, and information input or output through the constituting elements described above.

Also, the controller 27 may provide relevant information or process a function for the user by executing an application program stored in the memory 26 and controlling at least part of the constituting elements. Furthermore, the controller 27 may combine and operate at least two or more constituting elements among those constituting elements included in the electronic device 20 to operate the application program.

Also, the controller 27 may detect the motion of the electronic device 20 or user by using a gyroscope sensor, g-sensor, or motion sensor included in the sensing unit 23. Also, the controller 27 may detect an object approaching the vicinity of the electronic device 20 or user by using a proximity sensor, illumination sensor, magnetic sensor, infrared sensor, ultrasonic sensor, or light sensor included in the sensing unit 23. Besides, the controller 27 may detect the motion of the user through sensors installed at the controller operating in conjunction with the electronic device 20.

Also, the controller 27 may perform the operation (or function) of the electronic device 20 by using an application program stored in the memory 26.

The power supply unit 28 receives external or internal power under the control of the controller 27 and supplies the power to each and every constituting element included in the electronic device 20. The power supply unit 28 includes battery, which may be provided in a built-in or replaceable form.

At least part of the constituting elements described above may operate in conjunction with each other to implement the operation, control, or control method of the electronic device according to various embodiments described below. Also, the operation, control, or control method of the electronic device may be implemented on the electronic device by executing at least one application program stored in the memory 26.

In what follows, the electronic device according to one embodiment of the present invention will be described with reference to an example where the electronic device is applied to a Head Mounted Display (HMD). However, embodiments of the electronic device according to the present invention may include a mobile phone, smartphone, laptop computer, digital broadcast terminal, Personal Digital Assistant (PDA), Portable Multimedia Player (PMP), navigation terminal, slate PC, tablet PC, ultrabook, and wearable device. Wearable devices may include smart watch and contact lens in addition to the HMD.

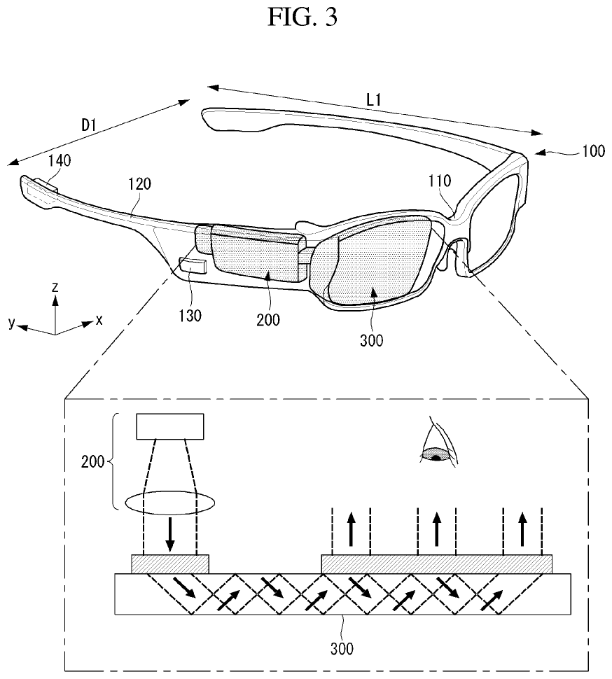

FIG. 3 is a perspective view of an AR electronic device according to one embodiment of the present invention.

As shown in FIG. 3, the electronic device according to one embodiment of the present invention may include a frame 100, controller 200, and display unit 300.

The electronic device may be provided in the form of smart glasses. The glass-type electronic device may be shaped to be worn on the head of the user, for which the frame (case or housing) 100 may be used. The frame 100 may be made of a flexible material so that the user may wear the glass-type electronic device comfortably.

The frame 100 is supported on the head and provides a space in which various components are installed. As shown in the figure, electronic components such as the controller 200, user input unit 130, or sound output unit 140 may be installed in the frame 100. Also, lens that covers at least one of the left and right eyes may be installed in the frame 100 in a detachable manner.

As shown in the figure, the frame 100 may have a shape of glasses worn on the face of the user; however, the present invention is not limited to the specific shape and may have a shape such as goggles worn in close contact with the user's face.

The frame 100 may include a front frame 110 having at least one opening and one pair of side frames 120 parallel to each other and being extended in a first direction (y), which are intersected by the front frame 110.

The controller 200 is configured to control various electronic components installed in the electronic device.

The controller 200 may generate an image shown to the user or video comprising successive images. The controller 200 may include an image source panel that generates an image and a plurality of lenses that diffuse and converge light generated from the image source panel.

The controller 200 may be fixed to either of the two side frames 120. For example, the controller 200 may be fixed in the inner or outer surface of one side frame 120 or embedded inside one of side frames 120. Or the controller 200 may be fixed to the front frame 110 or provided separately from the electronic device.

The display unit 300 may be implemented in the form of a Head Mounted Display (HMD). HMD refers to a particular type of display device worn on the head and showing an image directly in front of eyes of the user. The display unit 300 may be disposed to correspond to at least one of left and right eyes so that images may be shown directly in front of the eye(s) of the user when the user wears the electronic device. The present figure illustrates a case where the display unit 300 is disposed at the position corresponding to the right eye of the user so that images may be shown before the right eye of the user.

The display unit 300 may be used so that an image generated by the controller 200 is shown to the user while the user visually recognizes the external environment. For example, the display unit 300 may project an image on the display area by using a prism.

And the display unit 300 may be formed to be transparent so that a projected image and a normal view (the visible part of the world as seen through the eyes of the user) in the front are shown at the same time. For example, the display unit 300 may be translucent and made of optical elements including glass.

And the display unit 300 may be fixed by being inserted into the opening included in the front frame 110 or may be fixed on the front surface 110 by being positioned on the rear surface of the opening (namely between the opening and the user's eye). Although the figure illustrates one example where the display unit 300 is fixed on the front surface 110 by being positioned on the rear surface of the rear surface, the display unit 300 may be disposed and fixed at various positions of the frame 100.

As shown in FIG. 3, the electronic device may operate so that if the controller 200 projects light about an image onto one side of the display unit 300, the light is emitted to the other side of the display unit, and the image generated by the controller 200 is shown to the user.

Accordingly, the user may see the image generated by the controller 200 while seeing the external environment simultaneously through the opening of the frame 100. In other words, the image output through the display unit 300 may be seen by being overlapped with a normal view. By using the display characteristic described above, the electronic device may provide an AR experience which shows a virtual image overlapped with a real image or background as a single, interwoven image.

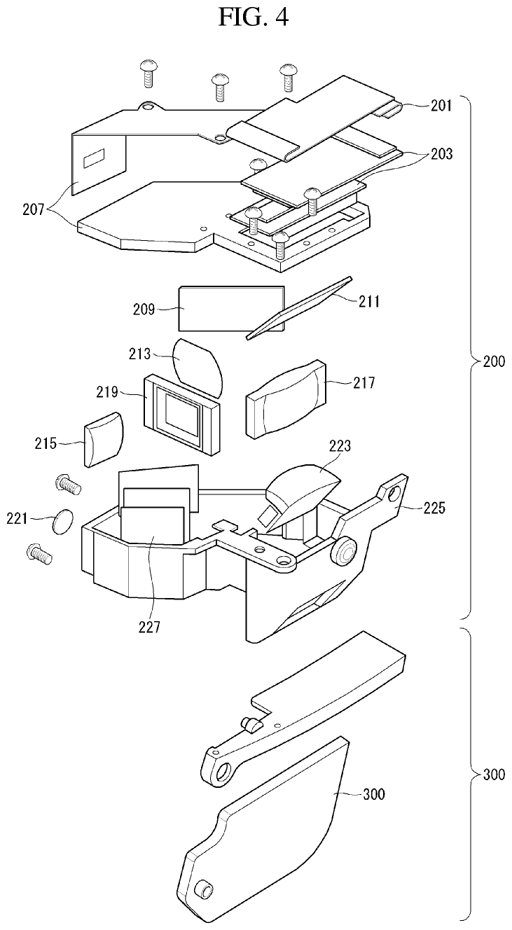

FIG. 4 is an exploded perspective view of a controller according to one embodiment of the present invention.

Referring to the figure, the controller 200 may include a first cover 207 and second cover 225 for protecting internal constituting elements and forming the external appearance of the controller 200, where, inside the first 207 and second 225 covers, included are a driving unit 201, image source panel 203, Polarization Beam Splitter Filter (PBSF) 211, mirror 209, a plurality of lenses 213, 215, 217, 221, Fly Eye Lens (FEL) 219, Dichroic filter 227, and Freeform prism Projection Lens (FPL) 223.

The first 207 and second 225 covers provide a space in which the driving unit 201, image source panel 203, PBSF 211, mirror 209, a plurality of lenses 213, 215, 217, 221, FEL 219, and FPL may be installed, and the internal constituting elements are packaged and fixed to either of the side frames 120.

The driving unit 201 may supply a driving signal that controls a video or an image displayed on the image source panel 203 and may be linked to a separate modular driving chip installed inside or outside the controller 200. The driving unit 201 may be installed in the form of Flexible Printed Circuits Board (FPCB), which may be equipped with heatsink that dissipates heat generated during operation to the outside.

The image source panel 203 may generate an image according to a driving signal provided by the driving unit 201 and emit light according to the generated image. To this purpose, the image source panel 203 may use the Liquid Crystal Display (LCD) or Organic Light Emitting Diode (OLED) panel.

The PBSF 211 may separate light due to the image generated from the image source panel 203 or block or pass part of the light according to a rotation angle. Therefore, for example, if the image light emitted from the image source panel 203 is composed of P wave, which is horizontal light, and S wave, which is vertical light, the PBSF 211 may separate the P and S waves into different light paths or pass the image light of one polarization or block the image light of the other polarization. The PBSF 211 may be provided as a cube type or plate type in one embodiment.

The cube-type PBSF 211 may filter the image light composed of P and S waves and separate them into different light paths while the plate-type PBSF 211 may pass the image light of one of the P and S waves but block the image light of the other polarization.

The mirror 209 reflects the image light separated from polarization by the PBSF 211 to collect the polarized image light again and let the collected image light incident on a plurality of lenses 213, 215, 217, 221.

The plurality of lenses 213, 215, 217, 221 may include convex and concave lenses and for example, may include I-type lenses and C-type lenses. The plurality of lenses 213, 215, 217, 221 repeat diffusion and convergence of image light incident on the lenses, thereby improving straightness of the image light rays.

The FEL 219 may receive the image light which has passed the plurality of lenses 213, 215, 217, 221 and emit the image light so as to improve illuminance uniformity and extend the area exhibiting uniform illuminance due to the image light.

The dichroic filter 227 may include a plurality of films or lenses and pass light of a specific range of wavelengths from the image light incoming from the FEL 219 but reflect light not belonging to the specific range of wavelengths, thereby adjusting saturation of color of the image light. The image light which has passed the dichroic filter 227 may pass through the FPL 223 and be emitted to the display unit 300.

The display unit 300 may receive the image light emitted from the controller 200 and emit the incident image light to the direction in which the user's eyes are located.

Meanwhile, in addition to the constituting elements described above, the electronic device may include one or more image capture means (not shown). The image capture means, being disposed close to at least one of left and right eyes, may capture the image of the front area. Or the image capture means may be disposed so as to capture the image of the side/rear area.

Since the image capture means is disposed close to the eye, the image capture means may obtain the image of a real world seen by the user. The image capture means may be installed at the frame 100 or arranged in plural numbers to obtain stereoscopic images.

The electronic device may provide a user input unit 130 manipulated to receive control commands. The user input unit 130 may adopt various methods including a tactile manner in which the user operates the user input unit by sensing a tactile stimulus from a touch or push motion, gesture manner in which the user input unit recognizes the hand motion of the user without a direct touch thereon, or a manner in which the user input unit recognizes a voice command. The present figure illustrates a case where the user input unit 130 is installed at the frame 100.

Also, the electronic device may be equipped with a microphone which receives a sound and converts the received sound to electrical voice data and a sound output unit 140 that outputs a sound. The sound output unit 140 may be configured to transfer a sound through an ordinary sound output scheme or bone conduction scheme. When the sound output unit 140 is configured to operate according to the bone conduction scheme, the sound output unit 140 is fit to the head when the user wears the electronic device and transmits sound by vibrating the skull.

In what follows, various forms of the display unit 300 and various methods for emitting incident image light rays will be described.

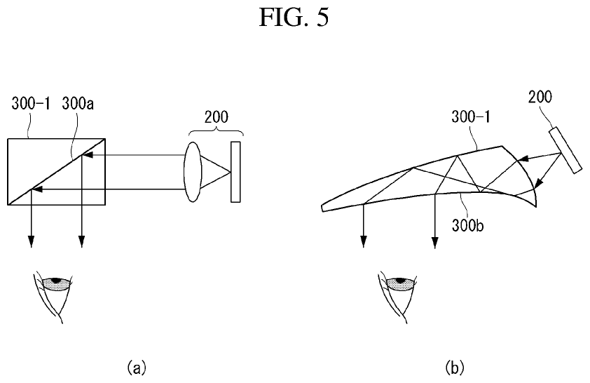

FIGS. 5 to 11 illustrate various display methods applicable to the display unit 300 according to one embodiment of the present invention.

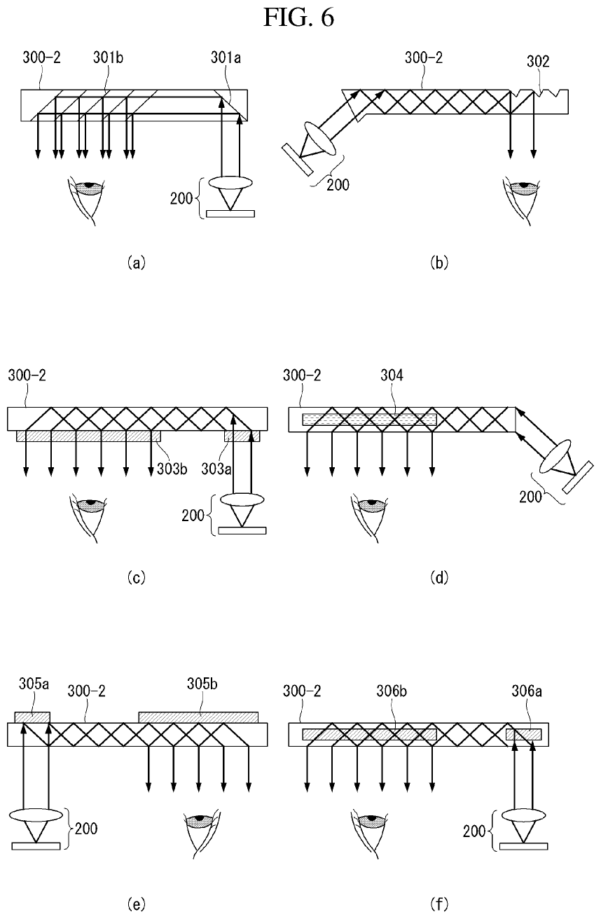

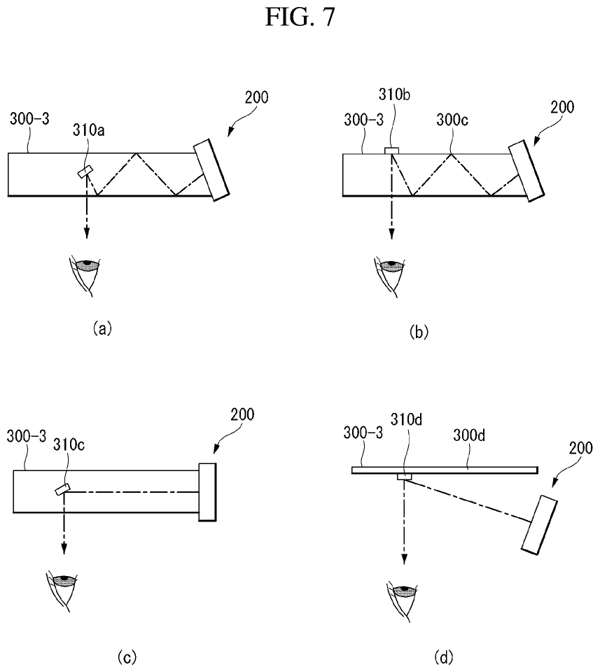

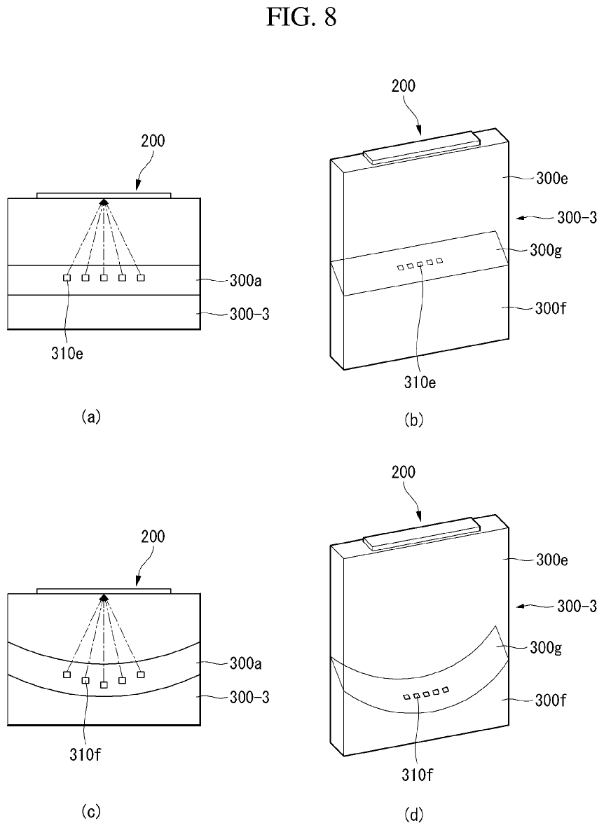

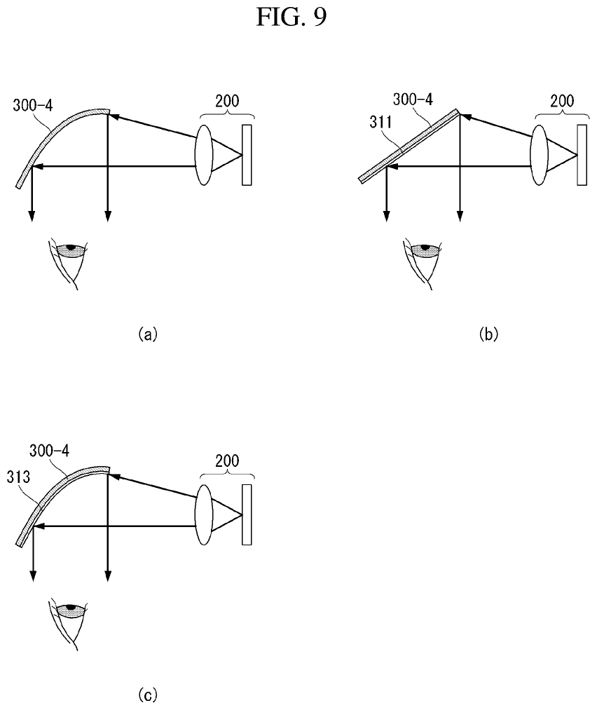

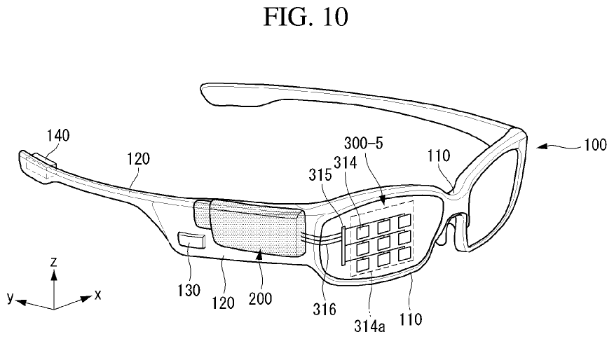

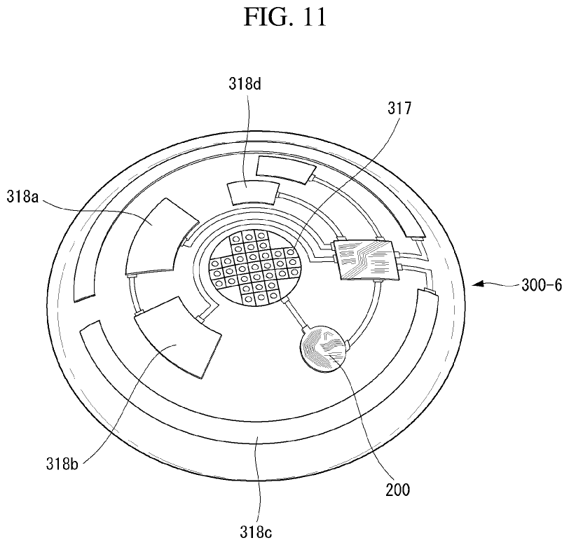

More specifically, FIG. 5 illustrates one embodiment of a prism-type optical element; FIG. 6 illustrates one embodiment of a waveguide-type optical element; FIGS. 7 and 8 illustrate one embodiment of a pin mirror-type optical element; and FIG. 9 illustrates one embodiment of a surface reflection-type optical element. And FIG. 10 illustrates one embodiment of a micro-LED type optical element, and FIG. 11 illustrates one embodiment of a display unit used for contact lenses.

As shown in FIG. 5, the display unit 300-1 according to one embodiment of the present invention may use a prism-type optical element.

In one embodiment, as shown in FIG. 5(a), a prism-type optical element may use a flat-type glass optical element where the surface 300a on which image light rays are incident and from which the image light rays are emitted is planar or as shown in FIG. 5(b), may use a freeform glass optical element where the surface 300b from which the image light rays are emitted is formed by a curved surface without a fixed radius of curvature.

The flat-type glass optical element may receive the image light generated by the controller 200 through the flat side surface, reflect the received image light by using the total reflection mirror 300a installed inside and emit the reflected image light toward the user. Here, laser is used to form the total reflection mirror 300a installed inside the flat type glass optical element.

The freeform glass optical element is formed so that its thickness becomes thinner as it moves away from the surface on which light is incident, receives image light generated by the controller 200 through a side surface having a finite radius of curvature, totally reflects the received image light, and emits the reflected light toward the user.

As shown in FIG. 6, the display unit 300-2 according to another embodiment of the present invention may use a waveguide-type optical element or light guide optical element (LOE).

As one embodiment, the waveguide or light guide-type optical element may be implemented by using a segmented beam splitter-type glass optical element as shown in FIG. 6(a), saw tooth prism-type glass optical element as shown in FIG. 6(b), glass optical element having a diffractive optical element (DOE) as shown in FIG. 6(c), glass optical element having a hologram optical element (HOE) as shown in FIG. 6(d), glass optical element having a passive grating as shown in FIG. 6(e), and glass optical element having an active grating as shown in FIG. 6(f).

As shown in FIG. 6(a), the segmented beam splitter-type glass optical element may have a total reflection mirror 301a where an optical image is incident and a segmented beam splitter 301b where an optical image is emitted.

Accordingly, the optical image generated by the controller 200 is totally reflected by the total reflection mirror 301a inside the glass optical element, and the totally reflected optical image is partially separated and emitted by the partial reflection mirror 301b and eventually perceived by the user while being guided along the longitudinal direction of the glass.

In the case of the saw tooth prism-type glass optical element as shown in FIG. 6(b), the optical image generated by the controller 200 is incident on the side surface of the glass in the oblique direction and totally reflected into the inside of the glass, emitted to the outside of the glass by the saw tooth-shaped uneven structure 302 formed where the optical image is emitted, and eventually perceived by the user.

The glass optical element having a Diffractive Optical Element (DOE) as shown in FIG. 6(c) may have a first diffraction unit 303a on the surface of the part on which the optical image is incident and a second diffraction unit 303b on the surface of the part from which the optical image is emitted. The first and second diffraction units 303a, 303b may be provided in a way that a specific pattern is patterned on the surface of the glass or a separate diffraction film is attached thereon.

Accordingly, the optical image generated by the controller 200 is diffracted as it is incident through the first diffraction unit 303a, guided along the longitudinal direction of the glass while being totally reflected, emitted through the second diffraction unit 303b, and eventually perceived by the user.

The glass optical element having a Hologram Optical Element (HOE) as shown in FIG. 6(d) may have an out-coupler 304 inside the glass from which an optical image is emitted. Accordingly, the optical image is incoming from the controller 200 in the oblique direction through the side surface of the glass, guided along the longitudinal direction of the glass by being totally reflected, emitted by the out-coupler 304, and eventually perceived by the user. The structure of the HOE may be modified gradually to be further divided into the structure having a passive grating and the structure having an active grating.

The glass optical element having a passive grating as shown in FIG. 6(e) may have an in-coupler 305a on the opposite surface of the glass surface on which the optical image is incident and an out-coupler 305b on the opposite surface of the glass surface from which the optical image is emitted. Here, the in-coupler 305a and the out-coupler 305b may be provided in the form of film having a passive grating.

Accordingly, the optical image incident on the glass surface at the light-incident side of the glass is totally reflected by the in-coupler 305a installed on the opposite surface, guided along the longitudinal direction of the glass, emitted through the opposite surface of the glass by the out-coupler 305b, and eventually perceived by the user.

The glass optical element having an active grating as shown in FIG. 6(f) may have an in-coupler 306a formed as an active grating inside the glass through which an optical image is incoming and an out-coupler 306b formed as an active grating inside the glass from which the optical image is emitted.

Accordingly, the optical image incident on the glass is totally reflected by the in-coupler 306a, guided in the longitudinal direction of the glass, emitted to the outside of the glass by the out-coupler 306b, and eventually perceived by the user.

The display unit 300-3 according to another embodiment of the present invention may use a pin mirror-type optical element.

The pinhole effect is so called because the hole through which an object is seen is like the one made with the point of a pin and refers to the effect of making an object look more clearly as light is passed through a small hole. This effect results from the nature of light due to refraction of light, and the light passing through the pinhole deepens the depth of field (DOF), which makes the image formed on the retina more vivid.

In what follows, an embodiment for using a pin mirror-type optical element will be described with reference to FIGS. 7 and 8.

Referring to FIG. 7(a), the pinhole mirror 310a may be provided on the path of incident light within the display unit 300-3 and reflect the incident light toward the user's eye. More specifically, the pinhole mirror 310a may be disposed between the front surface (outer surface) and the rear surface (inner surface) of the display unit 300-3, and a method for manufacturing the pinhole mirror will be described again later.

The pinhole mirror 310a may be formed to be smaller than the pupil of the eye and to provide a deep depth of field. Therefore, even if the focal length for viewing a real world through the display unit 300-3 is changed, the user may still clearly see the real world by overlapping an augmented reality image provided by the controller 200 with the image of the real world.

And the display unit 300-3 may provide a path which guides the incident light to the pinhole mirror 310a through internal total reflection.

Referring to FIG. 7(b), the pinhole mirror 310b may be provided on the surface 300c through which light is totally reflected in the display unit 300-3. Here, the pinhole mirror 310b may have the characteristic of a prism that changes the path of external light according to the user's eyes. For example, the pinhole mirror 310b may be fabricated as film-type and attached to the display unit 300-3, in which case the process for manufacturing the pinhole mirror is made easy.

The display unit 300-3 may guide the incident light incoming from the controller 200 through internal total reflection, the light incident by total reflection may be reflected by the pinhole mirror 310b installed on the surface on which external light is incident, and the reflected light may pass through the display unit 300-3 to reach the user's eyes.

Referring to FIG. 7(c), the incident light illuminated by the controller 200 may be reflected by the pinhole mirror 310c directly without internal total reflection within the display unit 300-3 and reach the user's eyes. This structure is convenient for the manufacturing process in that augmented reality may be provided irrespective of the shape of the surface through which external light passes within the display unit 300-3.

Referring to FIG. 7(d), the light illuminated by the controller 200 may reach the user's eyes by being reflected within the display unit 300-3 by the pinhole mirror 310d installed on the surface 300d from which external light is emitted. The controller 200 is configured to illuminate light at the position separated from the surface of the display unit 300-3 in the direction of the rear surface and illuminate light toward the surface 300d from which external light is emitted within the display unit 300-3. The present embodiment may be applied easily when thickness of the display unit 300-3 is not sufficient to accommodate the light illuminated by the controller 200. Also, the present embodiment may be advantageous for manufacturing in that it may be applied irrespective of the surface shape of the display unit 300-3, and the pinhole mirror 310d may be manufactured in a film shape.

Meanwhile, the pinhole mirror 310 may be provided in plural numbers in an array pattern.

FIG. 8 illustrates the shape of a pinhole mirror and structure of an array pattern according to one embodiment of the present invention.

Referring to the figure, the pinhole mirror 310 may be fabricated in a polygonal structure including a square or rectangular shape. Here, the length (diagonal length) of a longer axis of the pinhole mirror 310 may have a positive square root of the product of the focal length and wavelength of light illuminated in the display unit 300-3.

A plurality of pinhole mirrors 310 are disposed in parallel, being separated from each other, to form an array pattern. The array pattern may form a line pattern or lattice pattern.

FIGS. 8(a) and (b) illustrate the Flat Pin Mirror scheme, and FIGS. 8(c) and (d) illustrate the freeform Pin Mirror scheme.

When the pinhole mirror 310 is installed inside the display unit 300-3, the first glass 300e and the second glass 300f are combined by an inclined surface 300g disposed being inclined toward the pupil of the eye, and a plurality of pinhole mirrors 310e are disposed on the inclined surface 300g by forming an array pattern.

Referring to FIGS. 8(a) and (b), a plurality of pinhole mirrors 310e may be disposed side by side along one direction on the inclined surface 300g and continuously display the augmented reality provided by the controller 200 on the image of a real world seen through the display unit 300-3 even if the user moves the pupil of the eye.

And referring to FIGS. 8(c) and (d), the plurality of pinhole mirrors 310f may form a radial array on the inclined surface 300g provided as a curved surface.

Since the plurality of pinhole mirrors 300f are disposed along the radial array, the pinhole mirror 310f at the edge in the figure is disposed at the highest position, and the pinhole mirror 310f in the middle thereof is disposed at the lowest position, the path of a beam emitted by the controller 200 may be matched to each pinhole mirror.

As described above, by disposing a plurality of pinhole arrays 310f along the radial array, the double image problem of augmented reality provided by the controller 200 due to the path difference of light may be resolved.

Similarly, lenses may be attached on the rear surface of the display unit 300-3 to compensate for the path difference of the light reflected from the plurality of pinhole mirrors 310e disposed side by side in a row.

The surface reflection-type optical element that may be applied to the display unit 300-4 according to another embodiment of the present invention may employ the freeform combiner method as shown in FIG. 9(a), Flat HOE method as shown in FIG. 9(b), and freeform HOE method as shown in FIG. 9(c).

The surface reflection-type optical element based on the freeform combiner method as shown in FIG. 9(a) may use freeform combiner glass 300, for which a plurality of flat surfaces having different incidence angles for an optical image are combined to form one glass with a curved surface as a whole to perform the role of a combiner. The freeform combiner glass 300 emits an optical image to the user by making incidence angle of the optical image differ in the respective areas.

The surface reflection-type optical element based on Flat HOE method as shown in FIG. 9(b) may have a hologram optical element (HOE) 311 coated or patterned on the surface of flat glass, where an optical image emitted by the controller 200 passes through the HOE 311, reflects from the surface of the glass, again passes through the HOE 311, and is eventually emitted to the user.

The surface reflection-type optical element based on the freeform HOE method as shown in FIG. 9(c) may have a HOE 313 coated or patterned on the surface of freeform glass, where the operating principles may be the same as described with reference to FIG. 9(b).

In addition, a display unit 300-5 employing micro LED as shown in FIG. 10 and a display unit 300-6 employing a contact lens as shown in FIG. 11 may also be used.

Referring to FIG. 10, the optical element of the display unit 300-5 may include a Liquid Crystal on Silicon (LCoS) element, Liquid Crystal Display (LCD) element, Organic Light Emitting Diode (OLED) display element, and Digital Micromirror Device (DMD); and the optical element may further include a next-generation display element such as Micro LED and Quantum Dot (QD) LED.

The image data generated by the controller 200 to correspond to the augmented reality image is transmitted to the display unit 300-5 along a conductive input line 316, and the display unit 300-5 may convert the image signal to light through a plurality of optical elements 314 (for example, microLED) and emits the converted light to the user's eye.

The plurality of optical elements 314 are disposed in a lattice structure (for example, 100×100) to form a display area 314a. The user may see the augmented reality through the display area 314a within the display unit 300-5. And the plurality of optical elements 314 may be disposed on a transparent substrate.

The image signal generated by the controller 200 is sent to an image split circuit 315 provided at one side of the display unit 300-5; the image split circuit 315 is divided into a plurality of branches, where the image signal is further sent to an optical element 314 disposed at each branch. At this time, the image split circuit 315 may be located outside the field of view of the user so as to minimize gaze interference.

Referring to FIG. 11, the display unit 300-5 may comprise a contact lens. A contact lens 300-5 on which augmented reality may be displayed is also called a smart contact lens. The smart contact lens 300-5 may have a plurality of optical elements 317 in a lattice structure at the center of the smart contact lens.

The smart contact lens 300-5 may include a solar cell 318a, battery 318b, controller 200, antenna 318c, and sensor 318d in addition to the optical element 317. For example, the sensor 318d may check the blood sugar level in the tear, and the controller 200 may process the signal of the sensor 318d and display the blood sugar level in the form of augmented reality through the optical element 317 so that the user may check the blood sugar level in real-time.

As described above, the display unit 300 according to one embodiment of the present invention may be implemented by using one of the prism-type optical element, waveguide-type optical element, light guide optical element (LOE), pin mirror-type optical element, or surface reflection-type optical element. In addition to the above, an optical element that may be applied to the display unit 300 according to one embodiment of the present invention may include a retina scan method.

Unlike Hereinafter, the electronic device 20 according to the present disclosure may be referred to as an optical device, and the optical device may be implemented as an HMD worn by a user. The display module included in the electronic device 20 may be the same as a display module included in the optical device and for easy understanding, a display module according to the present disclosure will be described as an example in which the electronic device or optical device is applied as an HMD.

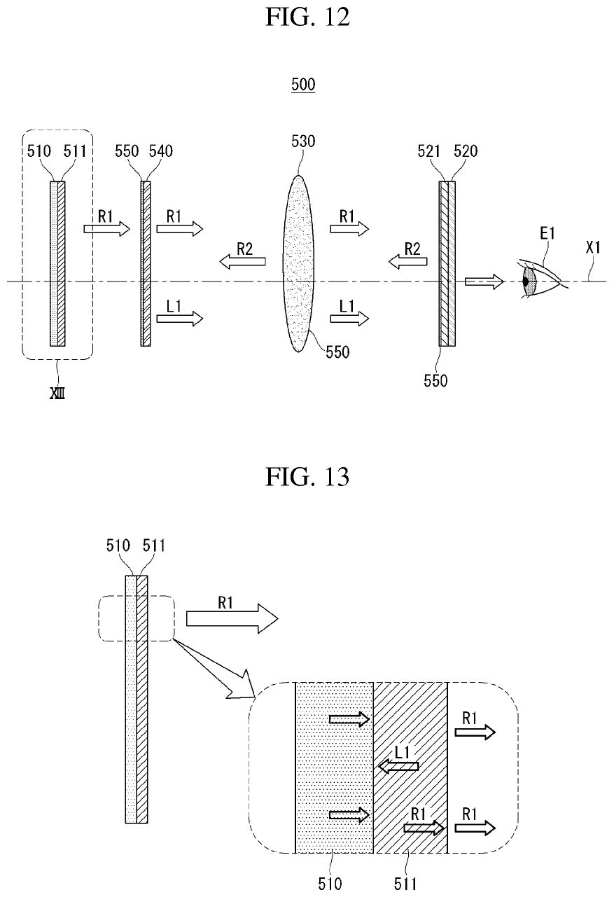

Hereinafter, the structure of the display module included in the optical device according to the present disclosure will be described with reference to FIGS. 12 to 17.

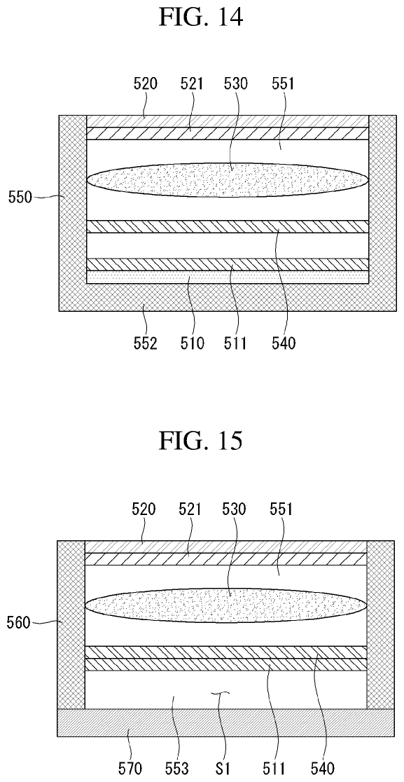

FIG. 12 is a diagram illustrating a configuration of a display module according to an embodiment of the present disclosure and FIG. 13 a diagram illustrating that a cholesteric liquid crystal film layer is deposited on one surface of the display panel according to the embodiment of the present disclosure. FIGS. 14 and 15 are diagrams illustrating examples of a barrel including the display module according to the embodiment of the present disclosure.

As illustrated in FIG. 12, a display module 500 included in the optical device according to an embodiment of the present disclosure includes a display panel 510, a reflective polarizer 520, a lens 530, and a half-mirror 540.

The display panel 510 is configured to emit light toward an eye E1 of a user, and the reflective polarizer 520 is configured to reflect the light emitted from the display panel 510. Therefore, the display panel 510 and the reflective polarizer 520 are arranged to face each other on an optical axis X1 defined by the eye E1 of the user. The lens 530 is disposed between the display panel 510 and the reflective polarizer 520 to allow the light emitted from the display panel 510 to be transmitted, and the half-mirror 540 reflects the light reflected from the reflective polarizer 520 back to pass through the lens 530, and then allows an image to be formed in the eye E1 of the user.

Referring to FIGS. 12 and 13, a cholesteric liquid crystal film layer 511 is laminated on a surface of the display panel 510 facing the eye E1. As described above, a portion where the cholesteric liquid crystal film layer (CLC) 511 is laminated and facing the eye of the user is referred to as one surface of the display panel.

In addition, a quarter-wave retarder film layer 521 is laminated on a surface of the reflective polarizer 520 facing the display panel 510. Here, the surface of the reflective polarizer 520 facing the display panel 510 may be referred to as the other surface of the reflective polarizer 520.

Meanwhile, the lens 530 is preferably a convex lens. In this case, both surfaces of the convex lens 530 are anti-reflection coated to prevent the surfaces from reflecting the light passing through the convex lens 530, thereby increasing the overall light efficiency of the display module.

As illustrated in FIG. 12, in the display module 500 according to the embodiment of the present disclosure, the reflective polarizer 520, the lens 530, the half-mirror 540, and the display panel 510 are sequentially disposed on the optical axis X1 defined by the eye E1 of the user in a direction away from a portion adjacent to the eye E1.

A process of displaying an image by the display module 500 according to the embodiment of the present disclosure will be described below with reference to FIG. 12. First, the light generated in the display panel 510 passes through the cholesteric liquid crystal film layer (CLC) 511 laminated on one surface of the display panel. In this case, the laminated CLC film layer 511 transmits right-circularly polarized light R1 and reflects left-circularly polarized light L1, of the light generated in the display panel 510.

Referring to FIG. 13, the left-circularly polarized light L1 reflected from the CLC film layer 511 is reflected toward one surface of the display panel 510, and the one surface of the display panel 510 may reflect the left-circularly polarized light L1 back, like a mirror. Therefore, since the left-circularly polarized light L1 lost while passing through the CLC film layer 511 is reflected back by a mirror effect of the display panel 510, in the display module 500 according to the embodiment of the present disclosure, the light efficiency may be increased as compared with the display module in the related art.

Meanwhile, the right-circularly polarized light R1 passing through the CLC film layer 511 is incident on the quarter-wave retarder film layer 521 laminated on the other surface of the reflective polarizer 520 through the half-mirror 540 and the lens 530. The right-circularly polarized light R1 experiences phase retardation while passing through the quarter-wave retarder film layer 521, and is reflected back by the reflective polarizer 520.

As described above, light R2 of which the phase is retarded while passing through the quarter-wave retarder film layer 521 and which is reflected by the reflective polarizer 520 is incident on the half-mirror 540 through the lens 530, and the half-mirror 540 reflects back the light R2 which is retarded by the quarter-wave retarder film layer 521 and then reflected by the reflective polarizer 520 to be incident on the eye E1 of the user through the lens 530.

The display module 500 according to the embodiment of the present disclosure configured as described above may be included in the HMD as the optical device by being disposed in a barrel 550, as illustrated in FIG. 14. The barrel 550 illustrated in FIG. 14 is a barrel 550 included in the HMD. In particular, among the types of the HMD, a barrel 550 is applied to a PC tethered HMD that is wired or wirelessly connected to an external digital device by way of example.

The barrel 550 has a space for accommodating the display module 500 therein and is configured to be disposed coaxially with the optical axis X1 defined by the eye of the user to align the display module 500 with the optical axis X1. Referring to FIG. 14, the barrel 550 included in the PC tethered HMD includes an opening 551 formed only on one side of the barrel 550 close to the eye E1 of the user, and an auxiliary frame 552 disposed for supporting the other surface of the display panel 510 on the other side thereof.

Therefore, when the user wears the PC tethered HMD, the eye E1 of the user may see an image or video output from the display panel 510 in a state of being cut off from the outside.

Meanwhile, FIG. 15 illustrates that the display module 500 according to the embodiment of the present disclosure is applied to a barrel 560 used for a drop-in type HMD. The drop-in type HMD is configured to mount an external digital device including a separate display panel 510 and does not include the display panel 510 inside the barrel 560 by itself. That is, as illustrated in FIG. 15, when the display module 500 according to the embodiment of the present disclosure is applied to the barrel 560 used for the drop-in type HMD, the display panel 510 included in the display module 500 may be replaced with a separate display panel 570 included in the external digital device.

Therefore, the barrel 560 illustrated in FIG. 15 includes a first opening 551 formed close to the eye E1 of the user and a second opening 553 formed farther from the eye than the first opening 551, the optical axis X1 defined by the eye E1 of the user passes through the centers of the first opening 551 and the second opening 553, and the display panel 570 of the external digital device may be viewed through the display module 550 disposed inside the barrel 560.

In addition, when the display panel 510 according to the embodiment of the present disclosure is referred to as a first display panel 510 and the display panel 570 of the external digital device may be referred to as a second display panel 570, the main frame forming the outline of the drop-in type HMD includes a fixing unit (not illustrated) capable of fixing an external digital device.

In particular, in a case of the drop-in type HMD, since there are various external digital devices that the user uses, for example, there are various types and sizes of smartphones, the external digital device is appropriately fixed to the main frame such that the second display panel 570 covers the second opening 553.

In addition, foreign matters or stains due to a fingerprint of a user may remain on the second display panel 570, and in a case where the CLC film layer 511 is located close to the second display panel 570 when the external digital device is fixed to the main frame, the foreign matters or stains may be visually recognized by the eye E1 of the user. Therefore, for the display module 500 applied to the drop-in type HMD, since the first panel 510 is replaced with the second display panel 570, it is preferable that the CLC film layer 511 is laminated on the other surface of the half-mirror 540 and a certain empty space Si is provided between the half-mirror 540 and the second display panel 570.

Meanwhile, the barrels 550 and 560 illustrated in FIGS. 14 and 15 are both accommodated in the main frame of the HMD.

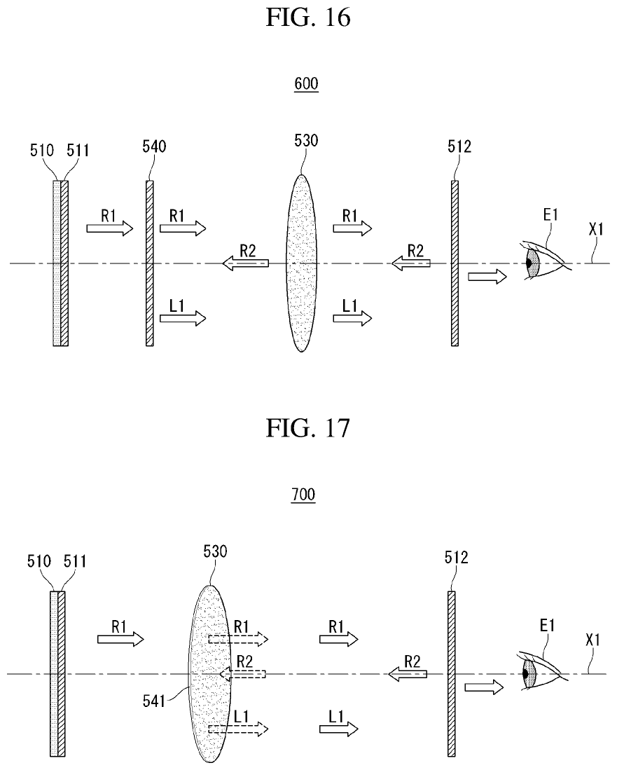

Hereinafter, a configuration of a display module 600 according to another embodiment of the present disclosure will be described with reference to FIG. 16. FIG. 16 is a diagram illustrating the configuration of the display module 600 according to the other embodiment of the present disclosure. In describing the display module 600 according to the other embodiment of the present disclosure, the same reference numerals may be used to refer to the same elements as those of the display module 500 according to the embodiment of the present disclosure, and in order to avoid repeated descriptions, detailed descriptions of the same configuration may be omitted.

The display module 600 according to the other embodiment of the present disclosure includes a cholesteric liquid crystal 512 instead of the reflective polarizer 520 included in the display module 500 according to the embodiment of the present disclosure. That is, in the display module 600 according to the other embodiment of the present disclosure, the cholesteric liquid crystal 512 is disposed at the location where the reflective polarizer 520 included in the display module 500 according to the embodiment of the present disclosure is disposed.

Referring to FIG. 16, the cholesteric liquid crystal film layer 511 laminated on the display panel 510 may be referred to as a first cholesteric liquid crystal layer 511, and the cholesteric liquid crystal 512 disposed instead of the reflective polarizer 520 may be referred to as a second cholesteric liquid crystal layer 512. In this case, the first cholesteric liquid crystal layer 511 may be configured to allow the right-circularly polarized light R1 to be transmitted among the light emitted from the display panel 510, and the second cholesteric liquid crystal layer 512 may be configured to allow the left-circularly polarized light L1 to be transmitted among the light passing through the lens 530.

As illustrated in FIG. 16, the light generated in the display panel 510 passes through the first cholesteric liquid crystal layer (CLC) 511 laminated on one surface of the display panel 510. In this case, the laminated CLC film layer 511 transmits right-circularly polarized light R1 and reflects left-circularly polarized light L1, among the light generated in the display panel 510.

As described above with reference to FIG. 11, the left-circularly polarized light L1 reflected from the first cholesteric liquid crystal layer 511 is reflected toward one surface of the display panel 510, and the surface of the display panel 510 may reflect the left-circularly polarized light L1 back, like a mirror. Therefore, since the left-circularly polarized light L1 reflected from the first cholesteric liquid crystal layer 511 is re-reflected by a mirror effect of the display panel 510, the light efficiency of the display module 600 according to the present embodiment may be increased as compared with the display module in the related art.

Meanwhile, the right-circularly polarized light R1 transmitted through the first cholesteric liquid crystal layer 511 is incident on the second cholesteric liquid crystal layer 512 through the half-mirror 540 and the lens 530. In this case, the second cholesteric liquid crystal layer 512 reflects the right-circularly polarized light R1 to the half-mirror 540. The right-circularly polarized light R2 reflected by the second cholesteric liquid crystal layer 512 is left-circularly polarized L1 through reflection by the half-mirror 540, and is incident on the eye E1 of the user.

The display module 600 according to the other embodiment of the present disclosure uses the cholesteric liquid crystal layer 512 instead of the reflective polarizer 520 to increase the ratio of finally transmitted light.

In addition, as the number of optical components of the display module 600 according to the other embodiment of the present disclosure is less than that of the embodiment, light reflection and light absorption that may occur in each component may be minimized and the light efficiency may be increased.

Hereinafter, a configuration of a display module 700 according to still another embodiment of the present disclosure will be described with reference to FIG. 17. FIG. 17 is a diagram illustrating a configuration of a display module according to still another embodiment of the present disclosure. In describing the display module 700 according to the still another embodiment of the present disclosure, the same reference numerals may be used to refer to the same elements as those in the display module 500 according to the embodiment of the present disclosure.

The display module 700 according to the still another embodiment of the present disclosure includes a half-mirror film layer 541 instead of the half-mirror 540 included in the display module 500 according to the embodiment of the present disclosure. In addition, the display module 700 according to the still another embodiment of the present disclosure includes the cholesteric liquid crystal 512 instead of the reflective polarizer 520 included in the display module 500 according to the embodiment of the present disclosure.

That is, in the display module 700 according to the still another embodiment of the present disclosure, as illustrated in FIG. 17, the half-mirror film layer 541 is laminated on the other surface of the lens 530 facing the display panel 510 and the half-mirror 540 included in the display module 500 according to the embodiment of the present disclosure is not separately disposed.

Meanwhile, referring to FIG. 17, the cholesteric liquid crystal film layer 511 laminated on the display panel 510 may be referred to as the first cholesteric liquid crystal layer 511, and the cholesteric liquid crystal 512 disposed instead of the reflective polarizer 520 may be referred to as the second cholesteric liquid crystal layer 512. In this case, the first cholesteric liquid crystal layer 511 may be configured to allow the right-circularly polarized light R1 to be transmitted among the light emitted from the display panel 510, and the second cholesteric liquid crystal layer 512 may be configured to allow the left-circularly polarized light L1 to be transmitted among the light passing through the lens 530.

Referring to FIG. 17, since the half-mirror film layer 541 is coated on the surface of the lens 530 facing the display panel 510 so that the number of the optical components, that is, the number of the elements, which are included in the display module 700 according to the still another embodiment of the present disclosure is less than that of other embodiment, the overall size, volume, thickness, and weight of the display module 700 may be minimized, and as a result, the size, volume, thickness, and weight of the HMD may also be minimized.

In addition, as the number of optical components of the display module 700 according to the still another embodiment of the present disclosure is less than those of other embodiments, light reflection and light absorption that may occur in each component may be minimized and the light efficiency may be increased.

Particular embodiments or other embodiments of the present invention described above are not mutually exclusive to each other or distinguishable from each other. Individual structures or functions of particular embodiments or other embodiments of the present invention described above may be used in parallel therewith or in combination thereof.

For example, it means that structure A described with reference to a specific embodiment and/or figure and structure B described with reference to other embodiment and/or figure may be combined together. In other words, even if a combination of two different structures is not explicitly indicated, it should be understood that combination thereof is possible unless otherwise stated as impossible.

The detailed descriptions above should be regarded as being illustrative rather than restrictive in every aspect. The technical scope of the present invention should be determined by a reasonable interpretation of the appended claims, and all of the modifications that fall within an equivalent scope of the present invention belong to the technical scope of the present invention.

### INDUSTRIAL APPLICABILITY

In the present specification, the example has been described based on an example applied to an electronic device used for VR (Virtual Reality), AR (Augmented Reality), MR (Mixed Reality) based on a 5G (5 generation) system, but may be applied to various wireless communication systems and electronic devices.

What is claimed is:

1. An optical device displaying an image in a short-distance, the optical device comprising a display module,
wherein the display module includes:
a display panel emitting light toward an eye of a user;
a reflective polarizer reflecting the light emitted from the display panel;
a lens disposed between the display panel and the reflective polarizer; and
a half-mirror reflecting the light reflected from the reflective polarizer back,
wherein a cholesteric liquid crystal film layer is laminated on one surface of the display panel facing the eye, and
wherein the reflective polarizer, the lens, the half-mirror, and the display panel are sequentially disposed on an optical axis defined by the eye in a direction away from a portion adjacent to the eye.

2. The optical device displaying an image in a short-distance of claim 1, wherein a quarter-wave retarder film layer is laminated on a surface of the reflective polarizer facing the display panel.

3. The optical device displaying an image in a short-distance of claim 2, wherein surfaces of the half-mirror and the quarter-wave retarder film layer facing the display panel are anti-reflection coated.

4. The optical device displaying an image in a short-distance of claim 1, wherein the lens is a convex lens.

5. The optical device displaying an image in a short-distance of claim 4, wherein both surfaces of the convex lens are anti-reflection coated.

6. The optical device displaying an image in a short-distance of claim 1,
wherein a cholesteric liquid crystal is disposed instead of the reflective polarizer, and
wherein when the cholesteric liquid crystal film layer laminated on the display panel is a first cholesteric liquid crystal layer and the cholesteric liquid crystal is a second cholesteric liquid crystal layer,
the first cholesteric layer right-circularly polarizes the light, and
the second cholesteric layer left-circularly polarizes the light.

7. The optical device displaying an image in a short-distance of claim 6,
wherein a half-mirror film layer is disposed instead of the half-mirror, and
wherein the half-mirror film layer is laminated on a surface of the lens facing the display panel.

8. The optical device displaying an image in a short-distance of claim 1, further comprising:
a barrel accommodating the display module therein and disposed coaxially with the optical axis to align the display module with the optical axis; and
a main frame having a space for accommodating the barrel,
wherein the barrel includes a first opening formed close to the eye and a second opening formed farther from the eye than the first opening, and
wherein the optical axis passes through the centers of the first and second openings.

9. The optical device displaying an image in a short-distance of claim 8, wherein the barrel further includes an auxiliary frame closing the second opening and supporting the other surface of the display panel.

10. The optical device displaying an image in a short-distance of claim 8,
wherein a display panel of an external digital device is disposed instead of the display panel,
wherein when the display panel is a first display panel and the display panel of the external digital device is a second display panel, the main frame includes a fixing unit fixing the external digital device, and
wherein when the external digital device is mounted on the fixing unit, the second display panel is disposed to cover the second opening and to allow second light generated in the second display panel to travel toward the eye.

11. The optical device displaying an image in a short-distance of claim 8, further comprising:
a head unit connected to the main frame,
wherein the head unit includes:
a headrest surrounding the head of the user; and
a band adjustable in length according to a head size of the user.

12. The optical device displaying an image in a short-distance of claim 1, further comprising:
a sensing unit for sensing an external digital device;
an inter-device communication module allowing data transmission and reception between the external digital device sensed by the sensing unit and the optical device;
a processor classifying information to be displayed on the display module when the information on the external digital device is received through the inter-device communication module; and
a memory storing data for operation of the optical device,
wherein the processor is configured to classify the information into graphical user interfaces stored in advance in the memory to display the classified information on the display module.

13. The optical device displaying an image in a short-distance of claim 12, further comprising:
an input unit receiving an input of the user,
wherein the processor is configured to execute a function corresponding to the input among functions stored in advance in the memory when the input of the user is received through the input unit.

14. The optical device displaying an image in a short-distance of claim 13,
wherein the input unit includes a camera or an image input unit for inputting an image signal, a microphone or an audio input unit for inputting an audio signal, and a user input unit (for example, a touch key or a mechanical key) for receiving information from the user.

15. The optical device displaying an image in a short-distance of claim 12,
wherein the sensing unit includes at least one of a proximity sensor, an illumination sensor, a touch sensor, an acceleration sensor, a magnetic sensor, a gravity (G)-sensor, a gyroscope sensor, a motion sensor, an RGB sensor, an infrared sensor (IR sensor), a fingerprint scan sensor, an ultrasonic sensor, an optical sensor, a microphone, a battery gauge, an environmental sensor including a barometer, a hygrometer, a thermometer, a radiation detection sensor, a heat detection sensor, and a gas detection sensor, and a chemical sensor including an electronic nose, a healthcare sensor, and a biometric sensor.

16. The optical device displaying an image in a short-distance of claim 12, further comprising:
at least one of a broadcast receiving module, a mobile communication module, a wireless internet module, a near field communication module, and a location information module as a network communication module.
